(19) United States
(12) Patent Application Publication
(10) Pub. No.: US 2009/0168625 A1
(43) Pub. Date: Jul. 2, 2009

(54) Micro-optical pickup

(76) Inventors: Chi-Hung Lee, Hsinchu (TW); Yi Chiu, Hsinchu (TW); Han-Ping D Shieh, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,584

(22) Filed: Mar. 7, 2008

(30) Foreign Application Priority Data
Dec. 28, 2007 (TW) 96150813

(51) Int. Cl. G11B 7/00

(52) U.S. Cl. 369/100

(57) ABSTRACT

A dynamic micro-machined optical device is applied in a micro-optical pickup. The micro-optical pickup includes an actuator and a dynamic grating, wherein the actuator may be a cantilever beam electrostatic actuator, a scratch drive actuator, a magnetic actuator or an electromagnetic actuator; and the actuator is controlled by applying an external voltage. The position of the dynamic grating is switchable between on and off the optical axis. When the external voltage is applied, the on-axis dynamic grating splits the light from a laser diode into multi-beams and the micro-optical pickup can rapidly retrieve information on the disk by simultaneously reading multi-tracks on the disk with multi low energy beams. When the external voltage is turned-off, the dynamic grating is off the optical axis and the light from the laser diode will pass directly and write information into the disk with single high energy beam.

### BACKGROUND OF THE INVENTION

1. Field of the Invention

The present invention relates to an optical pickup and, more particularly, relates to a micro-optical pickup utilizing a dynamic micro-machined optical device.

2. Description of the Prior Art

Microelectromechanical System (MEMS) technology is a micro system fabrication technology of integrating the optics, the machinery, the electron, the material and so on. MEMS is extensively applied in many fields, including the optical electricity, the information, the communication and the biomedicine. MEMS microminiaturizes the products to enhance the performance, quality and reliability, to raise up the additional value and to lower down the fabrication cost simultaneously. The micro-optical system integrates micro-optical devices on a single chip, and light can freely propagate in this micro system, so that technology can be extensively applied in various optoelectronic applications. For an example of the optical storage, the micro-optical pickup reduces the weight, minifies the scale and accelerates the reading speed to promote the system very much.

Please refer to FIG. 1, which is a structural diagram of a micro-optical pickup 100 implemented by a conventional MEMS technology. The conventional micro-optical pickup 100 is made of a plurality of three dimensional micro-optical devices—including a laser diode (LD) 140, configured on a silicon(Si) substrate 192, as the light source with light wavelength ranging from 350 to 800 nm, a beam splitter 110 for splitting light to a reflective light and transmissive light, a Fresnel focus lens 120 for focusing the incident light, a 45-degree reflective mirror 130 for reflecting the incident light and a 135-degree reflective mirror 150 for reflecting the incident light, wherein the beam splitter 110, the Fresnel focus lens 120, the 45-degree reflective mirror 130 and the 135-degree reflective mirror 150 are fabricated by MEMS technology.

The principle of micro-optical pickup 100 is illustrated as follows: when writing, a light emitted by the semiconductor laser, such as laser diode 140, passes through the beam splitter 110 and is focused to the surface of a disk 191 after passing a Fresnel focus lens 120 and being reflected by a 45-degree inclined reflective mirror 130 to write data on the disk 191; when reading, the light path is the same as in writing, then the light is reflected by the disk 191, and, after passing the Fresnel focus lens 120, the beam splitter 110 and being reflected by the 135 degree inclined reflective mirror 150, the light reaches the sensor 190 on the silicon substrate 192 and is converted into an electric signal.

As abovementioned, whenever writing or reading, only a single light beam is used by the micro-optical pickup 100, and therefore it is hard to speed up the reading. Besides, the light energy is lower in reading and higher in writing, so an additional circuit is needed to adjust light-energy of the laser diode 140, and that will cost more and reduce the performance.

In a prior art, a multi-beam liquid crystal diffraction optical device was integrated to a conventional optical pickup to have the effect of writing in single beam and reading in multiple beams. However, the size of the device is getting bigger and the manufacturing process can not be integrated into the semiconductor manufacturing process due to material problems, so it can not be realized in fabricating the micro-optical pickup.

### SUMMARY OF THE INVENTION

The advantages of the present invention will become apparent from the following description taken in conjunction with the accompanying drawings wherein are set forth, by way of illustration and example, certain embodiments of the present invention.

In order to solve the foregoing problems, the objective of the present invention is to provide a micro-optical pickup fabricating actuator, a dynamic grating, a beam splitter, a Fresnel focus lens, a 45 degree inclined reflective mirror, an object lens, an elliptical Fresnel focus lens, a 135 degree inclined reflective mirror, three dimension micro-optical device etc by MEMS technology.

One objective of the present invention is to provide a micro-optical pickup fabricating an actuator by MEMS technology to drive a dynamic grating as the single-beam and multi-beam switch. The actuator may be the cantilever beam electrostatic actuator, the scratch drive actuator, the magnetic actuator or the electro-magnetic actuator.

One objective of present invention is to provide a micro-optical pickup which in whole writing motion, the micro-optical pickup is set high energy single-beam and in whole reading motion, the micro-optical pickup is set multi-beam state with low energy.

Therefore, the micro-optical pickup of present invention has the merits of light weight, small size, simple structure, conforming system efficiency and low cost to effectively raise the speed of the optical pickup.

To achieve the objective mentioned above, one embodiment of the present invention is to provide a micro-optical pickup, including: a silicon substrate; a laser diode set on silicon substrate to emit a light source; a cantilever beam electrostatic actuator; a dynamic grating driven by a cantilever beam electrostatic actuator; a beam splitter; a Fresnel focus lens; a 45 degree inclined reflective mirror; an object lens; an elliptical Fresnel focus lens; a 135 degree inclined reflective mirror; and a light sensor array; wherein a cantilever beam electrostatic actuator, a dynamic grating, beam splitter, a Fresnel focus lens, a 45 degree inclined reflective mirror, an object lens, an elliptical Fresnel focus lens and a 135 degree inclined reflective mirror are fabricated by MEMS technology.

When the micro-optical pickup proceeding a writing motion, the dynamic grating is lifted off an optical axis, the laser diode emitting a laser light directly passing through the beam splitter and focused by the Fresnel focus lens, then, the 45 degree inclined reflective mirror reflecting the laser light, passing through the object lens and focused on the surface of a disk, and an information is written into the surface of the disk;

When the micro-optical pickup proceeding a reading motion, the dynamic grating is driven to approach the optical axis by the cantilever beam electrostatic actuator, the laser diode emitting the laser light spitted into multi-beams by the dynamic grating, passing the beam splitter and focused by the Fresnel focus lens, the 45 degree inclined reflective mirror reflecting the laser light, passing through the object lens and focused on the surface of the disk, the multi-beam reflected by the surface of the disk, then, passing through the object lens, the 45 degree inclined reflective mirror, the Fresnel focus lens and the beam splitter, focused by the elliptical Fresnel focus lens, finally reflected by the 135 degree inclined reflective mirror to the light sensor array, the signal light with an information data in the disk converted into an electric signal output.

Another embodiment of present invention is to provide a micro-optical pickup, including: a silicon substrate; a laser diode set on the silicon substrate to emit a light source; a scratch drive actuator; a dynamic grating driven by a scratch drive actuator; a beam splitter; a Fresnel focus lens; a 45 degree inclined reflective mirror; an object lens; an elliptical Fresnel focus lens; a 135 degree inclined reflective mirror; and a light sensor array, wherein a scratch drive actuator, a dynamic grating, beam splitter, a Fresnel focus lens, a 45 degree inclined reflective mirror, an object lens, an elliptical Fresnel focus lens and a 135 degree inclined reflective mirror are fabricated by MEMS technology.

When the micro-optical pickup proceeding a writing motion, the dynamic grating is lifted off an optical axis, the laser diode emitting a laser light directly passing through the beam splitter and focused by the Fresnel focus lens then, the 45 degree inclined reflective mirror reflecting the laser light, passing through the object lens and focused on the surface of a disk, and an information is wrote into the surface of the disk;

When the micro-optical pickup proceeding a reading motion, the dynamic grating is driven to approach the optical axis by the scratch drive actuator, the laser diode emitting the laser light spitted into multi-beams by the dynamic grating, passing through the beam splitter and focused by the Fresnel focus lens, the 45 degree inclined reflective mirror reflecting the laser light, passing the object lens and focused on the surface of the disk, the multi-beam reflected by the surface of the disk, then, passing through the object lens, the 45 degree inclined reflective mirror, the Fresnel focus lens and the beam splitter, focused by the elliptical Fresnel focus lens, finally reflected by the 135 degree inclined reflective mirror to the light sensor array, the signal light with an information data in the disk converted into an electric signal output.

Another embodiment of present invention is to provide a micro-optical pickup, including: a silicon substrate; a laser diode set on the silicon substrate to emit a light source; a magnetic actuator or an electromagnetic actuator; a dynamic grating driven by the magnetic actuator or the electromagnetic actuator; a beam splitter; a Fresnel focus lens; a 45 degree inclined reflective mirror; an object lens; an elliptical Fresnel focus lens; a 135 degree inclined reflective mirror; and a light sensor array, wherein the magnetic actuator or the electromagnetic actuator, the dynamic grating, the beam splitter, the Fresnel focus lens, the 45 degree inclined reflective mirror, the object lens, the elliptical Fresnel focus lens and the 135 degree inclined reflective mirror are fabricated by MEMS technology.

When the micro-optical pickup proceeding a writing motion, the dynamic grating is lifted off an optical axis, the laser diode emitting a laser light directly passing through the beam splitter and focused by the Fresnel focus lens then, the 45 degree inclined reflective mirror reflecting the laser light, passing through the object lens and focused on the surface of a disk, and an information is written into the surface of the disk;

When the micro-optical pickup proceeding a reading motion, the dynamic grating is driven to approach the optical axis by the magnetic actuator or the electromagnetic actuator, the laser diode emitting the laser light spitted into multi-beams by the dynamic grating, passing the beam splitter and focused by the Fresnel focus lens, the 45 degree inclined reflective mirror reflecting the laser light, passing the object lens and focused on the surface of the disk, the multi-beam reflected by the surface of the disk then pass the object lens, the 45 degree inclined reflective mirror, the Fresnel focus lens and the beam splitter, focused by the elliptical Fresnel focus lens, finally reflected by the 135 degree inclined reflective mirror to the light sensor array, the signal light with an information data in the disk converted into an electric signal output.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a structural diagram illustrating the conventional micro-optical pickup by MEMS technology;

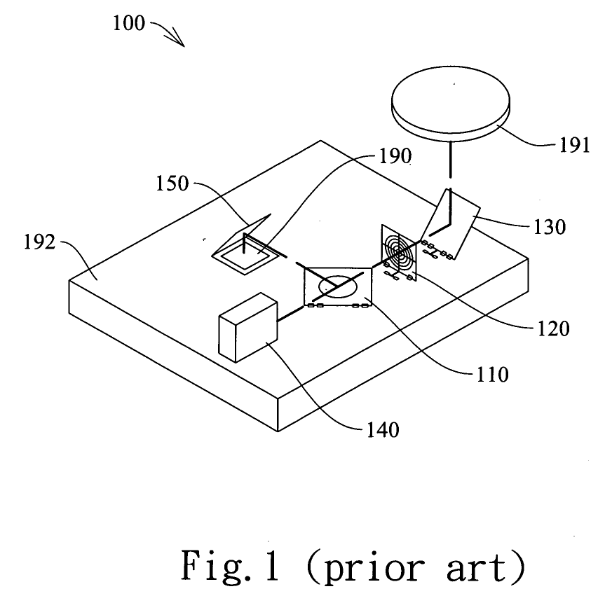

FIG. 2 is a structural diagram of writing motion according to the embodiment of present invention;

FIG. 3 is a structural diagram of reading motion according to first embodiment of present invention;

FIG. 4 is a structural diagram of writing motion according to second embodiment of present invention;

FIG. 5 is a structural diagram of reading motion according to second embodiment of present invention;

FIG. 6 is a structural diagram of writing motion according to third embodiment of present invention; and

FIG. 7 is a structural diagram of reading motion according to third embodiment of present invention.

### DESCRIPTION OF THE PREFERRED EMBODIMENT

The detailed explanation of the present invention is described as following. The described preferred embodiments are presented for purposes of illustrations and description, and they are not intended to limit the scope of the present invention.

The following illustrates three better embodiments according to the present invention.

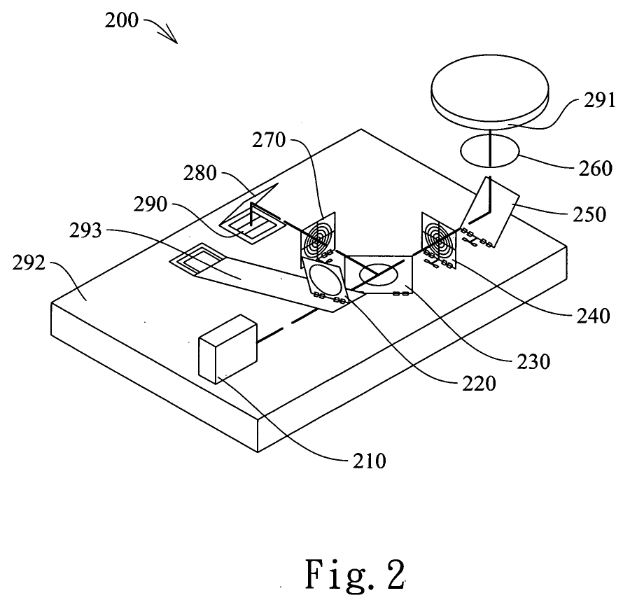

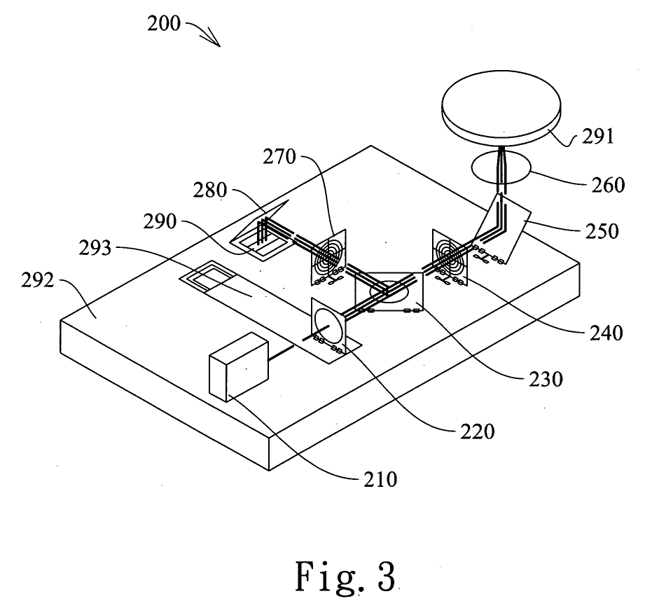

FIG. 2 is a structural diagram of showing the writing motion of the micro-optical pickup 200 and FIG. 3 for reading motion in accordance with the present invention. The micro-optical pickup 200 is made of plural three dimension optical devices. As shown in FIG. 2 and FIG. 3, a laser diode 210 configured on a silicon substrate 292 for emitting a laser light. A cantilever beam electrostatic actuator 293 is adhered on the silicon substrate 292 and connected to a dynamic grating 229 for driving the dynamic grating 220 on/off the axis of the laser light. A beam splitter 230, a Fresnel focus lens 240, and a 45 degree inclined reflective mirror 250 are arranged in order on the axis of the laser light, and then the laser light is focused by an object lens 260 to the surface of a disk 293. The light reflected by the disk 291 passes the an object lens 260, the 45 degree inclined reflective mirror 250, Fresnel focus lens 240 and the beam splitter 230 in reverse order, and is reflected and goes forward to and passes through an elliptical Fresnel focus lens 270 and a 135 degree inclined reflective mirror 280 to reaches a light sensor array 290. The mentioned cantilever beam electrostatic actuator 293, dynamic grating 220, beam splitter 230, Fresnel focus lens 240, 45 degree inclined reflective mirror 250, object lens 260, elliptical Fresnel focus lens 270 and 135 degree inclined reflective mirror 280 are fabricated by MEMS technology.

In one embodiment, the wavelength of the laser light emitted by the diode 140 ranges from 350 nm to 800 nm, the cantilever beam electrostatic actuator 293 is made of polysilicon and metal film, the dynamic grating 220 is made of periodic structure of silicon nitride and the light sensor array 290 is adhered on the surface of the silicon substrate 292 with a metallic or a high polymer adhesive.

The operation of the micro-optical pickup 200 i s briefly illustrated as follows:

In writing, shown in FIG. 2, the dynamic grating 220 is lifted off the optical axis of the laser light from the laser diode 210 by the cantilever beam electrostatic actuator 293, the laser light directly passes through the beam splitter 230, is focused by the Fresnel focus lens 340, reflected by the 45 degree inclined reflective mirror 250 and focused by the object lens 260 on the surface of the disk 291. In whole writing motion, the laser light is in a single-beam state to have high energy, so it can be used by the micro-optical pickup 200 to write data into the disk 291.

In reading, shown in FIG. 3, the dynamic grating 220 is lift on (inserted into) the optical axis of the laser light by the cantilever beam electrostatic actuator 293, and the laser light will be split into multiple laser beams by the dynamic grating 220. The multiple laser beams pass through the beam splitter 230 and the Fresnel focus lens 240, and are reflected by the 45 degree inclined reflective mirror 250, and then are focused by an object lens 260 on the surface of the disk 291. The multiple laser lights are reflected by the disk 291, and pass through the object lens 260, the 45 degree inclined reflective mirror 250 and the Fresnel focus lens 240, and then are lead by the beam splitter 230 to a direction perpendicular to the optical axis of the laser light. Continuously, the multiple laser lights pass the elliptical Fresnel focus lens 270, and are reflected by the 135 degree inclined reflective mirror 280, and finally reaches the light sensor array 290, which will convert the multiple laser lights to electric signals. In whole motion, the multiple laser lights split from the laser light of the laser diode 210 to have the lower energy, so it can be used by the micro-optical pickup 200 to read data from the disk.

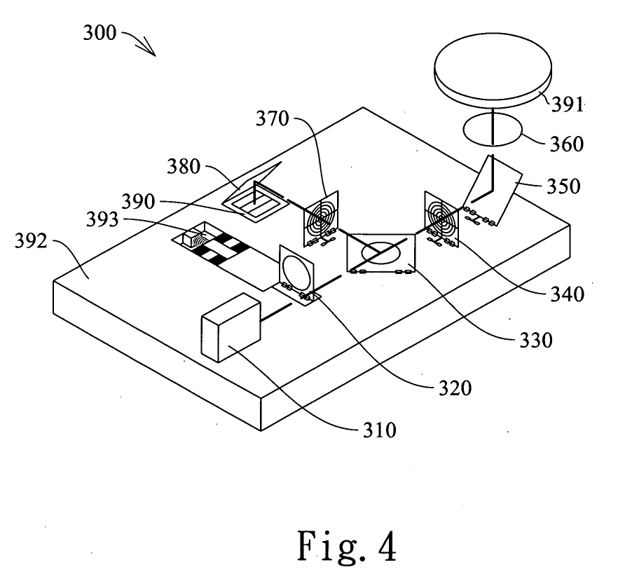

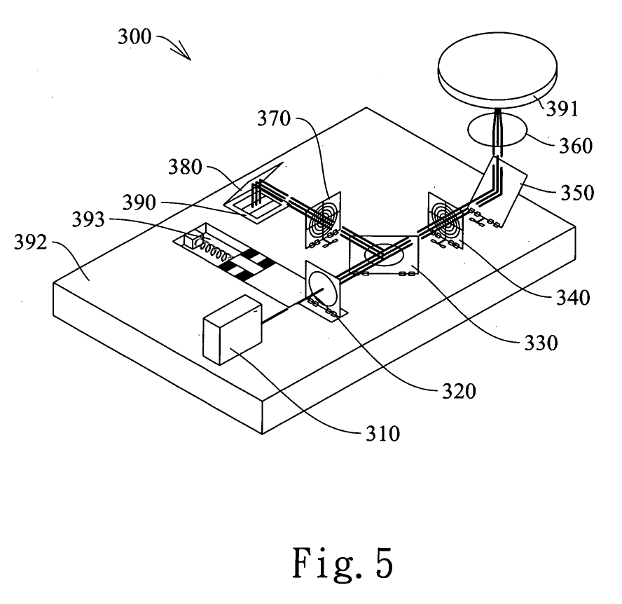

A second embodiment according to the present invention, shown in FIG. 4 and FIG. 5—FIG. 4 shows the writing motion and FIG. 5 for the reading motion of a micro-optical pickup 300. Similar with the first embodiment, in the second embodiment, the micro-optical pickup 300 uses a scratch drive actuator to drive the dynamic grating 320 instead of the cantilever beam electrostatic actuator in first embodiment.

In this embodiment, for the writing motion, the dynamic grating 220 is pulled off the optical axis of the laser light by the scratch drive actuator 393, and, for the reading motion, the dynamic grating 220 is pulled on (inserted into) the optical axis of the laser light. And, the scratch drive actuator 393, is also made of polysilicon and metallic film by MEMS technology.

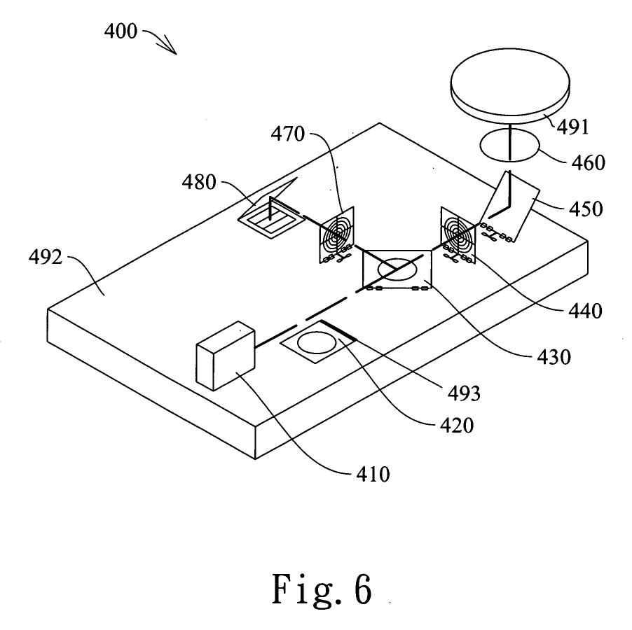

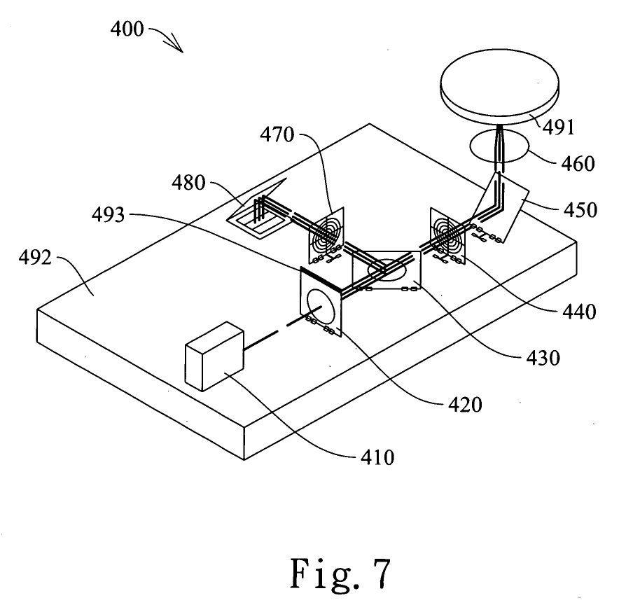

A third embodiment is show in FIG. 6 and FIG. 7—FIG. 6 for the writing motion and FIG. 7 for the reading motion. Similar with the first and the second embodiments, a magnetic actuator or an electro-magnetic actuator 493 are used by a micro-optical pickup 400 to drive a dynamic grating 420 instead of the cantilever beam electrostatic actuator in first embodiment and the scratch drive actuator in the second embodiment.

In this embodiment, the magnetic actuator or the electro-magnetic actuator 493 can move the dynamic grating 420 on or off the optical axis of the laser light to switch single/multi laser light to do the writing or reading motion.

Therefore the micro-optical pickup of the present invention has the following advantages. (1) The microminiturized components by MEMS technology, such as the actuator, the dynamic grating, the beam splitter, the Fresnel focus lens, the 45 degree inclined reflective mirror, the object lens, the elliptical Fresnel focus lens and the 135 degree inclined reflective mirror, three dimension optical devices etc. (2) The actuator drives the dynamic grating to switch the laser light of the laser diode into a single beam or a multiple beams, wherein the single beam has higher energy for writing and multiple beams have lower energy for reading, respectively. (3) The size, cost and weight are reduced, the structure is simplified and the efficiency is increased.

While the invention is susceptible to various modifications and alternative forms, a specific example thereof has-been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A micro-optical pickup, comprising:
a silicon substrate;
a laser diode configured on said silicon substrate to emit a laser light;
a dynamic grating splitting said laser light into a multi-beam laser light;
a cantilever beam electrostatic actuator connecting said silicon substrate and said dynamic grating to lift said dynamic grating on or off a axis of said laser light emitted by said laser diode; and
a beam splitter, a Fresnel focus lens and a 45 degree inclined reflective mirror configured on said silicon substrate and arranged in order on said axis of said laser light emitted by said laser diode, wherein said laser light or said multi-beam laser light passes through said beam splitter, said Fresnel focus lens and is reflected by said 45 degree inclined reflective mirror, then is focused by an object lens on a disk surface, and said multi-beam laser light is reflected by said disk, passes through said object lens, said 45 degree inclined reflective mirror, said beam splitter and is reflected by a 135 degree inclined reflective mirror to a light sensor array and is transferred to an electric signal.

2. The micro-optical pickup according to claim 1, wherein said cantilever beam electrostatic actuator, said dynamic grating, said beam splitter, said Fresnel focus lens, said 45 degree inclined reflective mirror, said object lens, said elliptical Fresnel focus lens and said 135 degree inclined reflective mirror are fabricated by a microelectromechanical system(MEMS) technology.

3. The micro-optical pickup according to claim 1, wherein the wavelength of said laser light emitted by said laser diode ranges from 350 nm to 800 nm.

4. The micro-optical pickup according to claim 1, wherein said cantilever beam electrostatic actuator is made of polysilicon and metal film.

5. The micro-optical pickup according to claim 1, wherein said light sensor array is adhered on the surface of said silicon substrate with a metallic or a high polymer adhesive.

6. A micro-optical pickup, comprising:
a silicon substrate;
a laser diode configured on said silicon substrate to emit a laser light;
a dynamic grating splitting said laser light into a multi-beam laser light;
a scratch drive actuator connecting said silicon substrate and said dynamic grating to lift said dynamic grating on or off a axis of said laser light emitted by said laser diode; and
a beam splitter, a Fresnel focus lens and a 45 degree inclined reflective mirror configured on said silicon substrate and arranged in order on said axis of said laser light emitted by said laser diode, wherein said laser light or said multi-beam laser light passes through said beam splitter, said Fresnel focus lens and is reflected by said 45 degree inclined reflective mirror, then is focused by an object lens on a disk surface, and said multi-beam laser light is reflected by said disk, passes through said object lens, said 45 degree inclined reflective mirror and said beam splitter, and is reflected by a 135 degree inclined reflective mirror to a light sensor array and is transferred to a electric signal.

7. The micro-optical pickup according to claim 6,wherein said scratch drive actuator, said dynamic grating, said beam splitter, said Fresnel focus lens, said 45 degree inclined reflective mirror, said object lens, said elliptical Fresnel focus lens and said 135 degree inclined reflective mirror are fabricated by MEMS technology.

8. The micro-optical pickup according to claim 6, wherein the wavelength of said laser emitted by said diode ranges from 350 nm to 800 nm.

9. The micro-optical pickup according to claim 6, wherein said scratch drive actuator is made of polysilicon and metal film.

10. The micro-optical pickup according to claim 6, wherein said light sensor array is adhered on the surface of said silicon substrate with a metallic or a high polymer adhesive.

11. A micro-optical pickup, comprising:
a silicon substrate;
a laser diode configured on said silicon substrate to emit a laser light;
a dynamic grating splitting said laser light into a multi-beam laser light;
a magnetic actuator or an electromagnetic actuator connecting said silicon substrate and said dynamic grating to lift said dynamic grating on or off a axis of said laser light emitted by said laser diode; and
a beam splitter, a Fresnel focus lens and a 45 degree inclined reflective mirror configured on said silicon substrate and arranged in order on said axis of said laser light emitted by said laser diode, wherein said laser light or multi-beam laser light passes through said beam splitter, said Fresnel focus lens and is reflected by said 45 degree inclined reflective mirror, then is focused by an object lens on a disk surface, and said multi-beam laser light is reflected by said disk, passes through said object lens, said 45 degree inclined reflective mirror, said beam splitter and is reflected by a 135 degree inclined reflective mirror, and is transferred to an electric signal.

12. The micro-optical pickup according to claim 11, wherein said magnetic actuator or said electromagnetic actuator, said dynamic grating, said beam splitter, said Fresnel focus lens, said 45 degree inclined reflective mirror, said object lens, said elliptical Fresnel focus lens and said 135 degree inclined reflective mirror are fabricated by MEMS technology.

13. The micro-optical pickup according to claim 11, wherein the wavelength of said laser emitted by said diode is from 350 nm to 800 nm.

14. The micro-optical pickup according to claim 11, wherein said magnetic actuator or said electromagnetic actuator is made of polysilicon and metal film.

15. The micro-optical pickup according to claim 11, wherein said light sensor array is adhered on the surface of said silicon substrate with a metallic or a high polymer adhesive.
